(19) United States
(12) Patent Application Publication
(10) Pub. No.: US 2004/0208608 A1
(43) Pub. Date: Oct. 21, 2004

(54) Dispersion compensation architecture for switch-ready optical networks

(76) Inventors: Alex Tager, Kanata (CA); John Gruber, Orleans (CA); Hanan Anis, Kanata, CA (US); Andrew Robinson, Ottawa (CA); Ross Saunders, Ottawa (CA)

Correspondence Address: HARNESS, DICKEY & PIERCE, P.L.C., P.O. BOX 828, BLOOMFIELD HILLS, MI, 48303, US

(21) Appl. No.: 10/178,284

(22) Filed: Jun. 24, 2002

(51) Int. Cl. H04B 10/00; H04B 10/12

(52) U.S. Cl. 398/147

(57) ABSTRACT

A dispersion compensation architecture for a switch-ready optical network includes an identified, switch-ready optical network region having a maximum propagation length, a dispersion section of the region having a section length, and dispersion compensation measures operably applied to said dispersion section, wherein the dispersion compensation measures are selected based on at least one determined regional target value of regional aggregated dispersion, the section length, and the maximum propagation length.

### FIELD OF THE INVENTION

The present invention generally relates to optical communication systems, and particularly relates to dispersion compensation in switch-ready LH and ULH networks.

### BACKGROUND OF THE INVENTION

There is considerable interest today in providing core optical networks that are flexible, reconfigurable, cost-efficient, and capable of supporting growing traffic demands. Achieving these goals requires elimination of costly (Optical-Electrical-Optical) OEO conversions and per wavelength electrical regeneration in switch-ready Long-Haul (LH) and Ultra-Long-Haul (ULH) optical networks. Thus, reconfigurable, multi-channel optical networks with a high degree of transparency are favored over point-to-point optical connections with electrical switch fabrics.

Past optical networks have typically used fixed point-to-point optical links ˜600 km or less (LH), in combination with electrical switch fabrics. Unless all the switch ports at every node are pre-equipped and hard-wired to per-channel transponders, which is prohibitive from the cost point of view, they are difficult to reconfigure if traffic demand changes. A large number of required electrical regenerators quickly reduces the system's cost efficiency as the number of nodes and channels increases.

Newer ULH (2000 km-4000 km) networks have much higher optical reach that allows reduction of the number of OEO conversions, and add optical flex points, such as Optical Add-Drop Multiplexers (OADMs) at traffic ingress-egress points. These networks, however, are optimized for ULH transport and are much more expensive than traditional LH links, which makes their use for short-link demands economically inefficient and requires additional LH systems to accommodate short demands. One obstacle to providing a transparent, switch-ready optical network that supports ULH and LH traffic is the set of problems associated with chromatic dispersion.

Chromatic dispersion is one aspect of deterioration of an optical signal due to propagation through optical fiber, and long links can result in considerable chromatic dispersion. Further, the deterioration and hence the amount and character of reconditioning depends on the particular combination of link dispersion and non-linearity the signal-bearing light has experienced, which makes it difficult to accommodate signals with different “histories” (different ingress locations) at the same receiver site. Still further, the transmission fiber dispersion is wavelength dependent (“dispersion slope”), and thus a different amount of compensation is required for different optical channels. This path-dependent and wavelength-dependent deterioration of the optical signal has been one of the biggest principle obstacles for implementation of optical switching and wavelength routing, and past solutions have failed to adequately address these problems.

Several solutions have been either implemented or proposed that fail to adequately address the aforementioned problems. For example, one suggested solution requires periodically de-multiplexing the transmitted signal along the link down to individual channels for per-channel dispersion compensation and amplification, greatly increasing system cost. Another solution has been to make these systems non-transparent at switch points, thus requiring electrical regeneration to “condition” the signals. A further solution is to use low bit-rates and thus increase the number of transponders to mediate path-dependent signal deterioration. Thus, ULH links are being complemented with electrical and/or opaque optical switches, which include per-channel OEO converters in the core, driving the network cost still higher.

The need remains for a solution to the problems associated with compensating for chromatic dispersion in a transparent, switch-ready optical network. Providing such a solution remains the task of the present invention.

### SUMMARY OF THE INVENTION

The present invention is a dispersion compensation architecture for a switch-ready optical network. The architecture comprises an identified, switch-ready optical network region having a maximum propagation length, a dispersion section of the region having a section length, and dispersion compensation measures operably applied to said dispersion section, wherein the dispersion compensation measures are selected based on at least one determined regional target value of regional aggregated dispersion, the section length, and the maximum propagation length.

In general, the present invention replaces a link-centered dispersion architecture, wherein a link is defined as a path from EO to OE, with a section-centered architecture suitable for mesh networks. In the present invention, the dispersion map of each section (between switch points) is constructed independently on particular ingress-egress points of any traffic going through the section to support a maximum reach for each path going through. An important advantage is preservation of transparent switchability.

The present invention is advantageous over previous dispersion compensation architectures in that it supports transparent switching while reducing costly OEO conversions. The present invention is further advantageous in that it incorporates strategic sub-band-level (and/or wavelength/channel level) dispersion compensation of wavelengths for which it is not possible to achieve the target dispersion at the maximum propagation length, while reducing the need for tunable dispersion compensation measures at receiving nodes in ULH networks.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a block diagram depicting identified, switch-ready optical network regions according to the present invention.

FIG. 2A is a block diagram depicting dispersion sections of an identified, switch-ready optical network region according to the present invention.

FIG. 2b is a block diagram depicting switch planes according to the present invention.

FIG. 3 is a two-dimensional graph depicting accumulated dispersion versus propagation length according to an exact compensation scheme.

FIG. 4 is a two-dimensional graph depicting accumulated dispersion versus propagation length according to an under-compensation scheme.

FIG. 5 is a two-dimensional graph depicting accumulated dispersion versus propagation length according to a sectionalized under-compensation scheme according to the present invention.

FIG. 6 is a two-dimensional graph depicting accumulated dispersion versus propagation length according to a sectionalized over-compensation scheme according to the present invention.

FIG. 7 is a flow chart diagram depicting a method of constructing a sectionalized dispersion compensation architecture according to the present invention.

FIG. 8 is a two-dimensional graph depicting a regional dispersion tolerance window according to the present invention.

FIG. 9 is a two-dimensional graph depicting signal quality versus dispersion compensation level for a 4000 km propagation length.

FIG. 10 is a two-dimensional graph depicting signal quality versus dispersion compensation level for various section lengths.

FIG. 11 is a two-dimensional graph depicting optimum average line dispersion versus section length according to the present invention.

FIG. 12 is a flow chart diagram depicting a method of performing partial dispersion compensation according to the present invention.

FIG. 13 is a two-dimensional graph depiction sectionalized dispersion compensation according to the present invention.

FIG. 14 is a two-dimensional graph depicting partially sectionalized dispersion compensation with sub-band-level compensation according to the present invention.

FIG. 15 is a schematic block diagram of a dispersion sectionalized optical communications system according to the present invention.

### DETAILED DESCRIPTION OF THE PREFERRED EMBODIMENTS

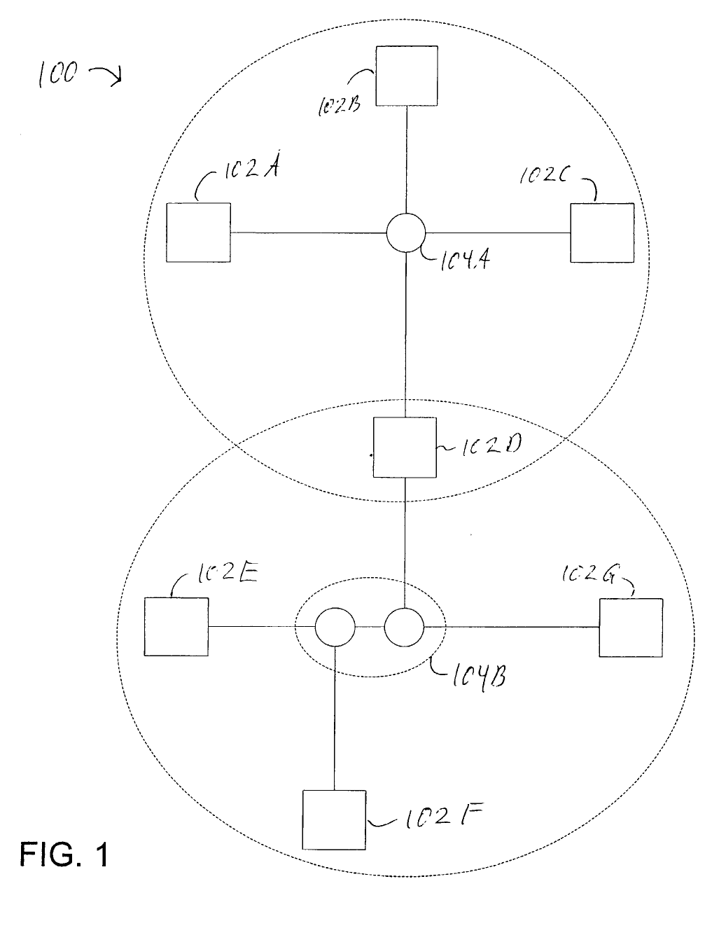

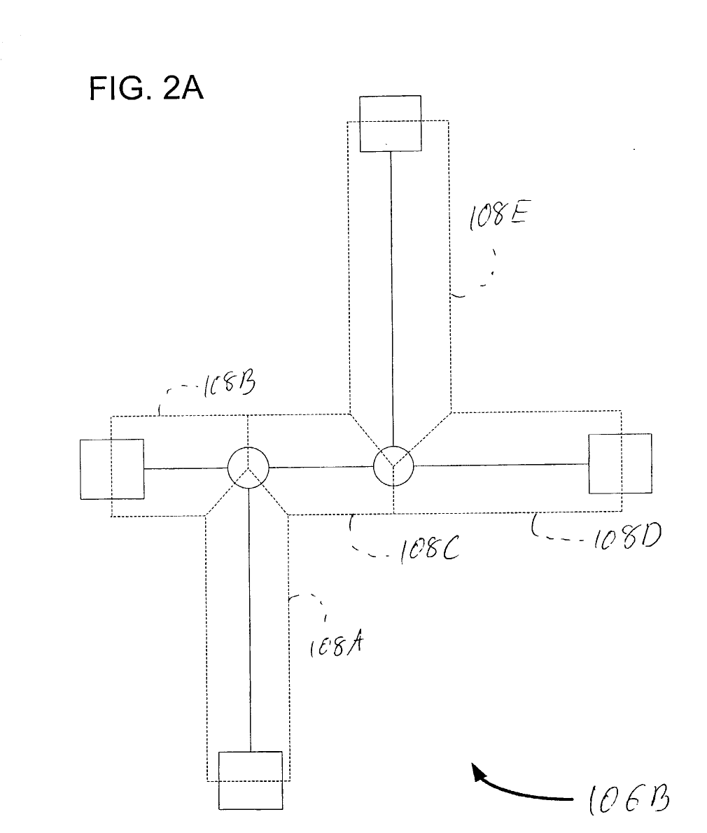

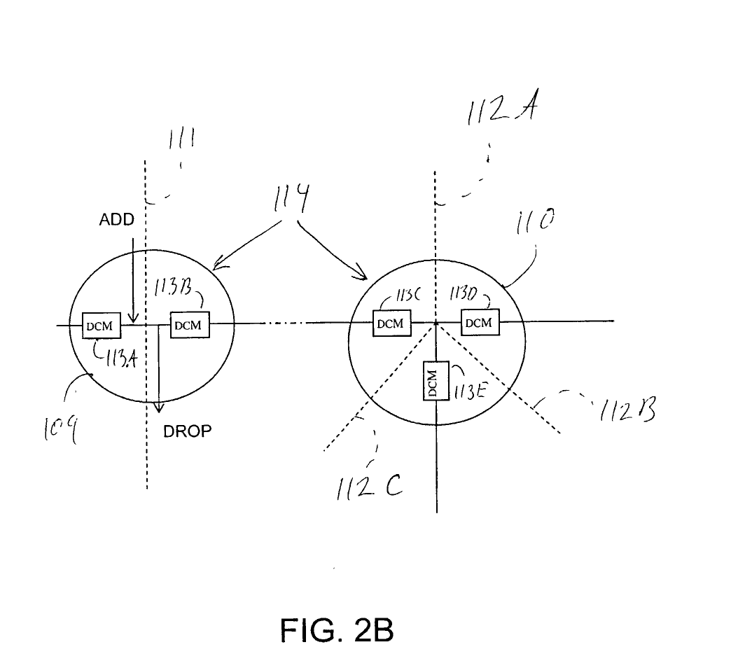

The present invention is a dispersion compensation architecture for use with switch ready optical networks, wherein dispersion sections of an identified, switch-ready optical network region are dispersion compensated to accommodate switching within the region without requiring costly OEO conversions. An identified, switch ready optical network region and a dispersion section of the region are defined more fully below with reference to FIGS. 1 and 2.

Referring to FIG. 1, an optical communications system 100 is composed of edge nodes 102A-102G (transponders, transmitting nodes, receiving nodes, regenerators, etc.) and optical switching nodes 104A and 104B, wherein it is conceivable that optical switching nodes may also add and drop traffic at times, but are operable to route optical signals between edge nodes without causing the signals to exit the optical domain. Identified, switch-ready optical network regions 106A and 106B have edge nodes requiring OEO conversions and an all-optical core switching fabric of optical switching nodes. For example, identified, switch-ready optical network region 106B has edge nodes 102D-102G and plurality of switching nodes 104B. Boundaries of an identified, switch-ready region exist wherever the optical signal exits the optical domain, and boundaries may be wavelength specific. Thus, where a regenerator always regenerates certain specific, but not all, wavelengths of the transmission band, the boundary exists at the regenerator for those wavelengths but not for the pass-through traffic. Similarly, a transmitting and/or receiving node may also transparently switch some traffic while dropping and adding others, and the region is bounded at such a node only for traffic that is added or dropped. In a more general sense, boundaries of an identified, switch-ready optical network region exist at edge nodes. At a minimum, an identified, switch-ready region must include at least three nodes, wherein at least one node is a transmitting node, at least one node is a switching node, and at least one node is a receiving node, and wherein at least two potential paths of transparent transmission exist within the region from the transmitting node to the receiving node.

Referring to FIG. 2A, identified, switch-ready region 106B is composed of dispersion sections 108A-108E corresponding to complimentary portions of two neighboring nodes and the optical transmission medium providing communication between the two neighboring nodes. The portions are complimentary in that they comprise the same link between neighboring nodes. A dispersion section may be composed of complimentary portions of two switching nodes as with section 108C. Also, a dispersion section may be composed of complimentary portions of a switching node and a transmitting and/or receiving node as with sections 108A, 108B, and 108D. Further, a dispersion section may be composed of complimentary portions of a switching node and a regenerator as with section 108E. Notably, a regenerator receives and regenerates signals, but without adding or dropping traffic, and, thenceforth, a regenerator is treated the same as and referred to in the same way as a transmitting and/or receiving node.

The boundaries of dispersion sections are further described as switch planes that cut through nodes in FIG. 2B. Therein, an add-drop node 109 is a two-degree node and a switching node 110 is a three-degree node. Switch planes 111 and 112A-112C exist where traffic is switchably and transparently routed from one node to another. Dispersion compensation measures (DCMs) 113A-113E correspond to section band pre- and post-compensators, and there may also be amplifier sites with line DCMs in-between the nodes. Complimentary portions 114 of neighboring nodes 109 and 110 are bounded by switch planes 111, 112A and 112C. Together with the optical propagation medium of the link, they comprise the dispersion section between the nodes.

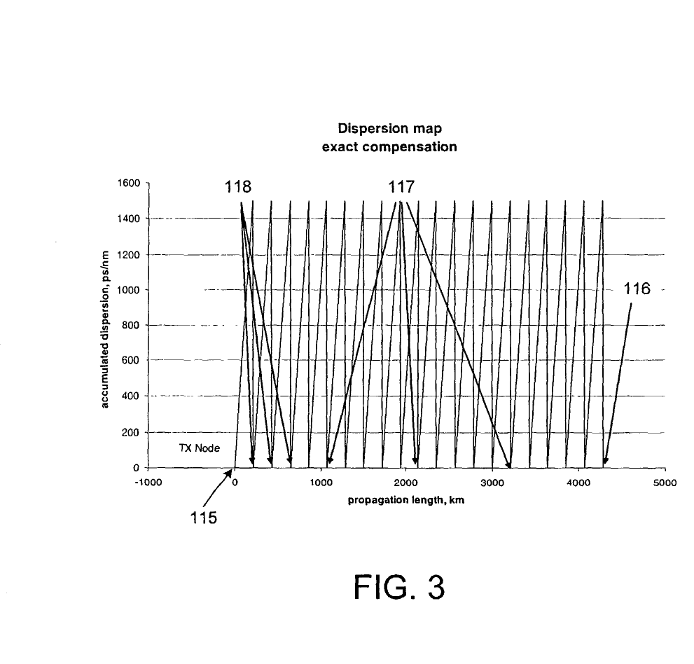

One seemingly attractive way of performing dispersion compensation in an identified, switch ready optical network region is discussed with reference to FIG. 3, wherein accumulated dispersion versus propagation length according to an exact compensation scheme is shown. Therein, chromatic dispersion in an optical signal proceeding from a transmitting site 115 to a receiving site 116 through switching sites 117 is compensated for via line compensators at line sites 118 and at each node. According to this exact compensation scheme, the line compensators are chosen to precisely compensate for preceding fiber dispersion (from the receiver or from the last line compensator) due to propagation though the optical transmission medium. Unfortunately, exact compensation yields high non-linear penalties, and reduces optical reach, such that exact compensation is not practicable with ULH networks. Thus, pre- and/or post compensation schemes with either over-compensation or under-compensation at line sites is generally preferred, especially with ULH networks.

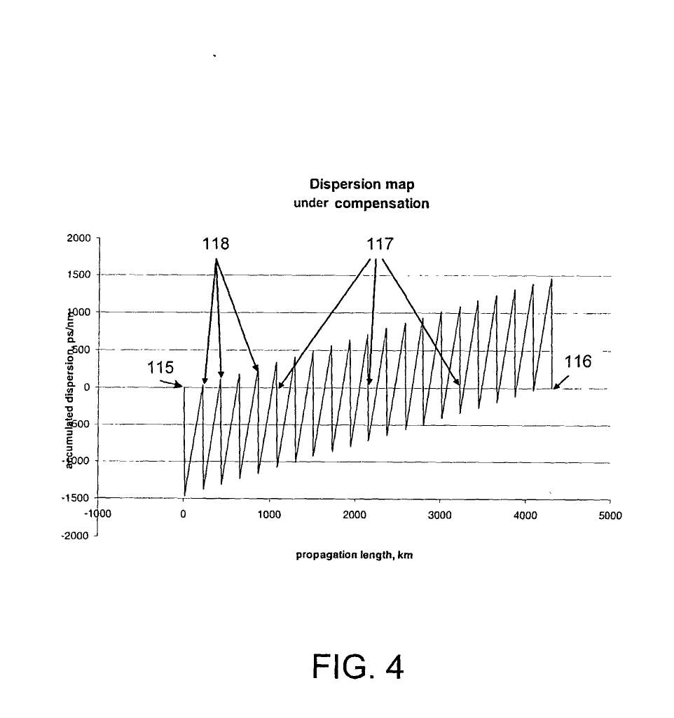

An example of an under-compensation scheme is shown in FIG. 4, wherein dispersion is pre- and post-compensated at nodes and band-level line compensators have an absolute dispersion value smaller than that of the preceding span. This scheme is unsuitable in that accumulated dispersion at network nodes depends on signal history, such that a region practicing this scheme is not truly switch-ready. Such a network region could support ULH propagation, but would require a large number of wide range adjustable post-compensators at receiving nodes to accommodate switching.

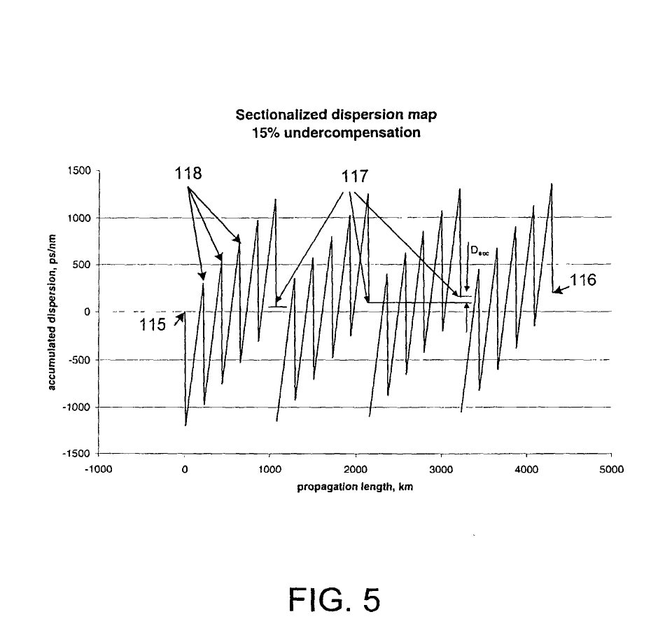

In contrast to the dispersion compensation schemes of FIGS. 3 and 4, the sectionalized dispersion compensation scheme of the present invention accommodates switching of traffic while reducing the need for tunable dispersion compensation measures at receiving nodes. FIG. 5 illustrates a sectionalized dispersion compensation scheme wherein a positive net map dispersion leads to an upward trend of accumulated dispersion within a section, and dispersion compensation measures for a section are chosen to achieve a fraction of an overall dispersion tolerance for the identified, switch-ready optical network region, wherein the fraction is based on a comparison of the section length to a maximum propagation length of the identified, switch-ready optical network region. This scheme ensures that an optical signal may be switched from one receiving site to another with reduced requirement for a tunable DCM and without requiring a costly OEO conversion.

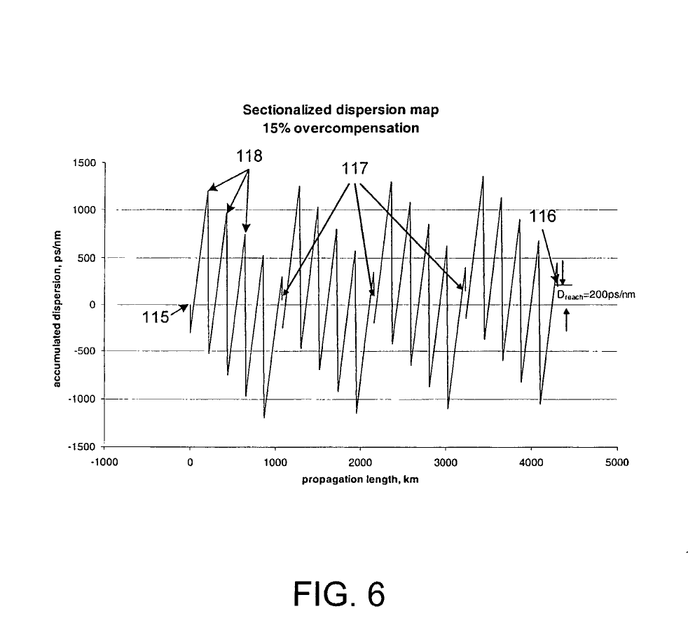

FIG. 6 illustrates a similar dispersion compensation scheme according to the present invention, wherein over-compensation has been employed within each section. Thus, the negative net map dispersion leads to a downward accumulated dispersion trend within each section, while a positive net link dispersion trend. Additional dispersion compensation schemes according to the present invention may be extrapolated, wherein under and over compensation schemes within sections may be combined with a negative net link dispersion trend.

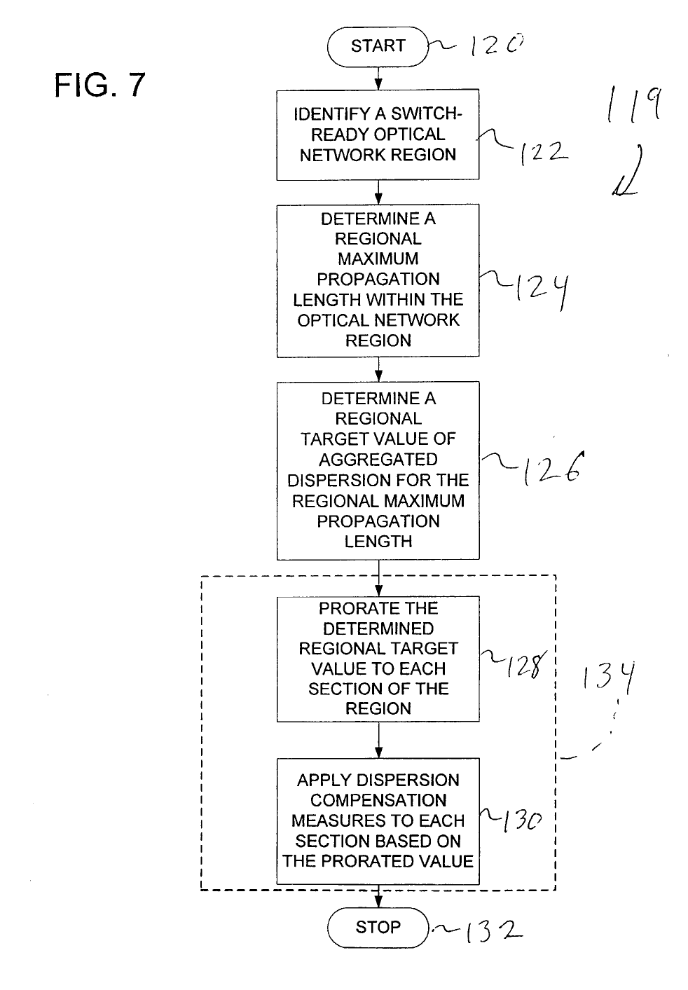

A method 119 of constructing a sectionalized dispersion compensation architecture according to the present invention is illustrated in FIG. 7. The method 119 begins at 120 and proceeds to step 122, wherein a switch-ready optical network region is identified. This region is preferably the entire network, but need for regenerators, pre-existence of regenerators, need to add to a pre-existing network, and/or the need to join two optical networks together may result in an identified, switch-ready region corresponding to less than an entire network. Identification of the switch-ready region may also take into account a need for growth in the network and/or future transition of components in the network from non-transparent to transparent components based on future availability of technology, funds, time, and/or convenience.

Following identification of the switch-ready optical network region at step 122, the method 119 proceeds to step 124, wherein a maximum propagation length within the identified, switch-ready optical network region is determined. Preferably, this length is chosen based on the optical reach within the network and based on distortion and noise accumulation rather than physical boundaries of the present day network. For example, an edge node defining a region boundary can later become a switch node when the network is upgraded. Also, new fiber may be laid and new nodes added. Further, two or more existing networks may be integrated together. Thus, the dispersion compensation architecture is preferably not necessarily limited to existing boundaries, but strives for the maximum possible reach with the line equipment, fiber type(s), etc. of the identified switch-ready region. Notably, the maximum propagation length cannot extend beyond the optical reach within the existing or future, expanded switch-ready region, and, since optical reach can be fiber-dependent, existence of multiple fiber types within a region may lead to a fiber-dependent maximum propagation length.

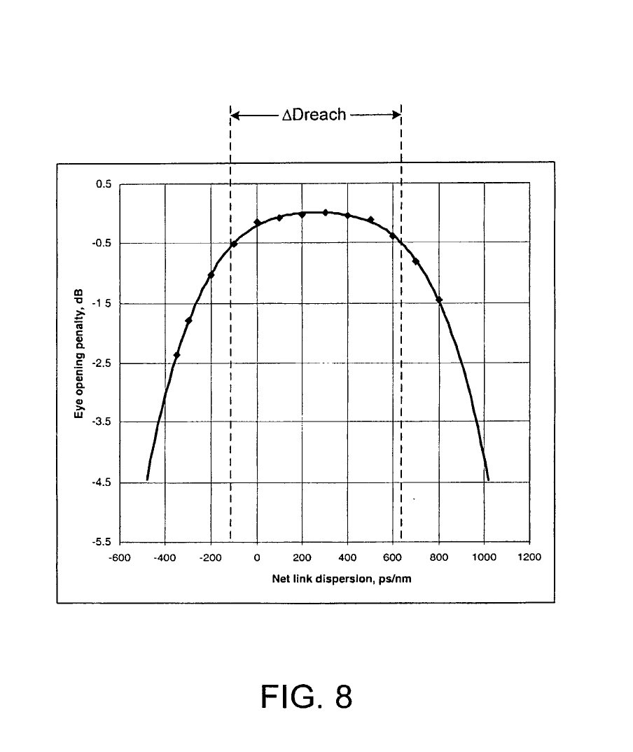

With the maximum propagation length determined at step 124, the method 119 proceeds to step 126, wherein a regional target value of aggregated dispersion for the maximum propagation length is determined. In general, this regional target value is determined based on a worst case scenario involving the maximum propagation length, dispersion tolerance of system receiving nodes, modulation format of the optical signal, optical power level of the optical signal, and fiber type(s) of the optical transmission medium. This regional target value can be non-zero and normally positive, which helps to reduce nonlinear impairments caused by self-phase modulation. For example, FIG. 8 demonstrates that signal quality is not always optimized at zero total accumulated link dispersion, but may be improved at a total link dispersion accumulated from transmitter to receiver above zero.

Simulation techniques known to those skilled in the art, such as a split-step Fourier method taught by Agrawal G. P., Nonlinear Fiber Optics, 2^{nd} edition, New York: Academic Press, 1995, herein incorporated by reference, can be used to pre-calculate this regional target value. For example, when an RZ modulated optical signal is propagated through NZDSF fiber links with fiber effective area ˜70 um², nonlinear coefficient n₂˜2.6*10⁻²⁰ m²/W, dispersion coefficient ˜7.5 ps/nm/km, and the optical power entering each fiber span ˜0.5-1 mW, one can expect the regional target value D_{reach} to be −300 ps/nm for a maximum propagation length ˜4000 km. This case is demonstrated in FIG. 8. Based on this information, a dispersion tolerance window ΔD_{reach} can be defined that preserves signal quality within tolerance of system receivers at the maximum propagation length. For example, if system budget allocates 0.5 dB of eye closure penalty to account for non-optimal accumulated dispersion at maximum reach, and the eye closure penalty versus accumulated dispersion at maximum reach is as described by FIG. 8, then ΔD_{reach} ˜700 ps/nm. Thus, a plurality of regional target values may be determined.

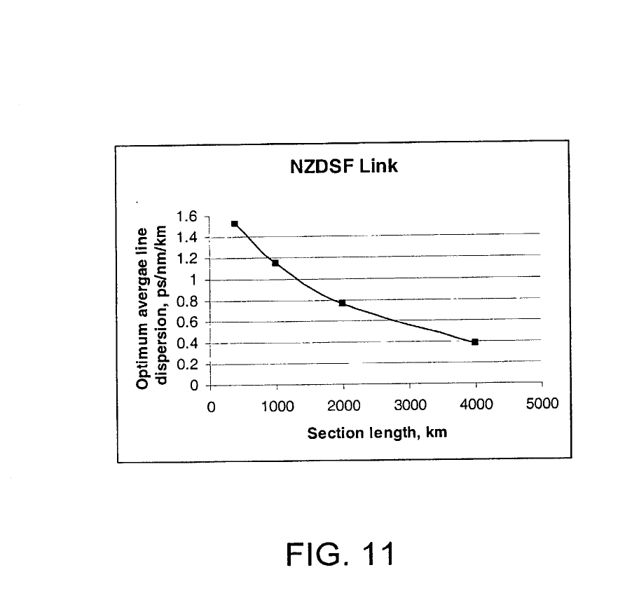

With the regional target value(s) determined in step 126, the method 119 proceeds to step 128, wherein the determined regional target value is prorated to each dispersion section of the identified, switch-ready optical network region. For example, in the above mentioned case wherein the regional target value ˜300 ps/nm for a maximum propagation length ˜4000 km, a linear rule for calculation of the regional target value could then be used. In this case, a 1000 km section could have a target dispersion of ˜300*(1000/4000)˜75 ps/nm. In more general terms, the linear rule may be expressed as:

$${D}_{sec} = {D}_{reach} * \frac{{L}_{sec}}{{L}_{reach}} ,$$

where D_{sec} corresponds to a sectional target value, D_{reach} corresponds to the regional target value, L_{sec} corresponds to the section length, and L_{reach} corresponds to the maximum propagation length. Notably, D_{reach} should be understood to be equivalent to ΔD_{reach}, as it is a simple matter to include a ±value in the calculation, so long as the value is similarly prorated. For example, if one wishes to prorate the dispersion tolerance window of FIG. 11 to a 400 km section, then if the dispersion tolerance window corresponds to (300 ps/nm+350 ps/nm), then the sectional window is (300 ps/nm±315 ps/nm)*400 km/400 km=(30 ps/nm±35 ps/nm). Thence, a plurality of sectional target values may be determined that define a sectional dispersion tolerance window. Similarly, a plurality of sectional target values may also be determined from a single sectional target value.

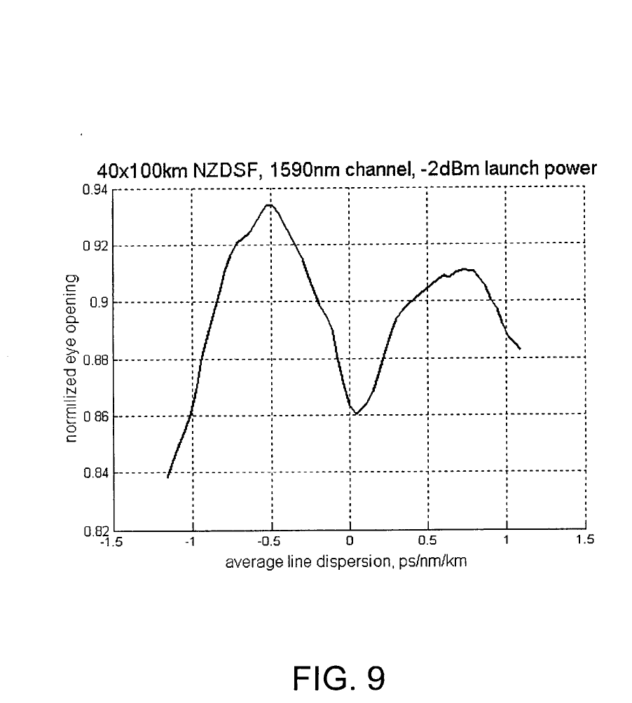

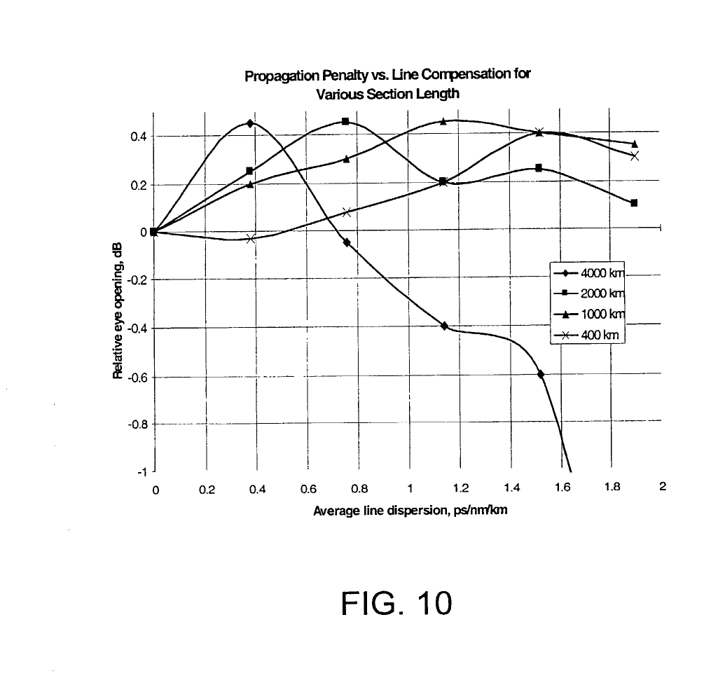

With the regional target value prorated to the dispersion sections of the identified, switch-ready optical network region, method 119 proceeds to step 130, wherein dispersion compensation measures are operably applied to corresponding dispersion sections based on their prorated values. In general, these measures take the form of band-level pre-, post-, and line dispersion compensators operably disposed inline with the optical transmission medium of each dispersion section at points of transmission wherein the optical transmission medium is transmitting the optical signal band. The line dispersion compensators may be chosen not to exactly compensate for chromatic dispersion in the preceding fiber spans, but instead to provide on average positive or negative line dispersion, leading to an upward or downward accumulated dispersion trend as shown in FIGS. 5 and 6. This choice helps to decrease nonlinear signal distortion due to such effects as self-phase modulation (SPM) and cross-phase modulation (XPM). For example, FIG. 9 demonstrates that signal quality is not always optimized at a zero averaged (including the effect of line compensators) line dispersion, but may improve at an average line dispersion above or below zero. Further, FIG. 10 demonstrates that dependency of signal quality versus averaged line dispersion varies according to section length. An example of optimal averaged line dispersion dependency on section length is further plotted in FIG. 11. In accordance with these examples, then in the case of a dispersion section with length of 400 km and a maximum propagation length of 4000 km, line compensators may first be applied to the section according to FIGS. 10 and 11. Then, pre- and post-compensators may be chosen for the section according to the optimum average line dispersion of FIG. 11. For example, the 400 km section can be comprised of four 100 km spans of transmission fiber with an optical amplifier sites after each span. Further, one can chose to use for the section two approximately equal line compensators symmetrically placed after the first and third fiber spans, and further choose their compensation value so that the combined dispersion of the four spans and the two line compensators can be (400 km*1.5 ps/nm/km)=600 ps/nm. Further, since 400 km is 10% of 4000 km, and 30 ps/nm is 10% of 300 ps/nm, then the target dispersion of the pre- and post-compensators may be chosen according to ((600 ps/nm-30 ps/nm)/2)=285 ps/nm.

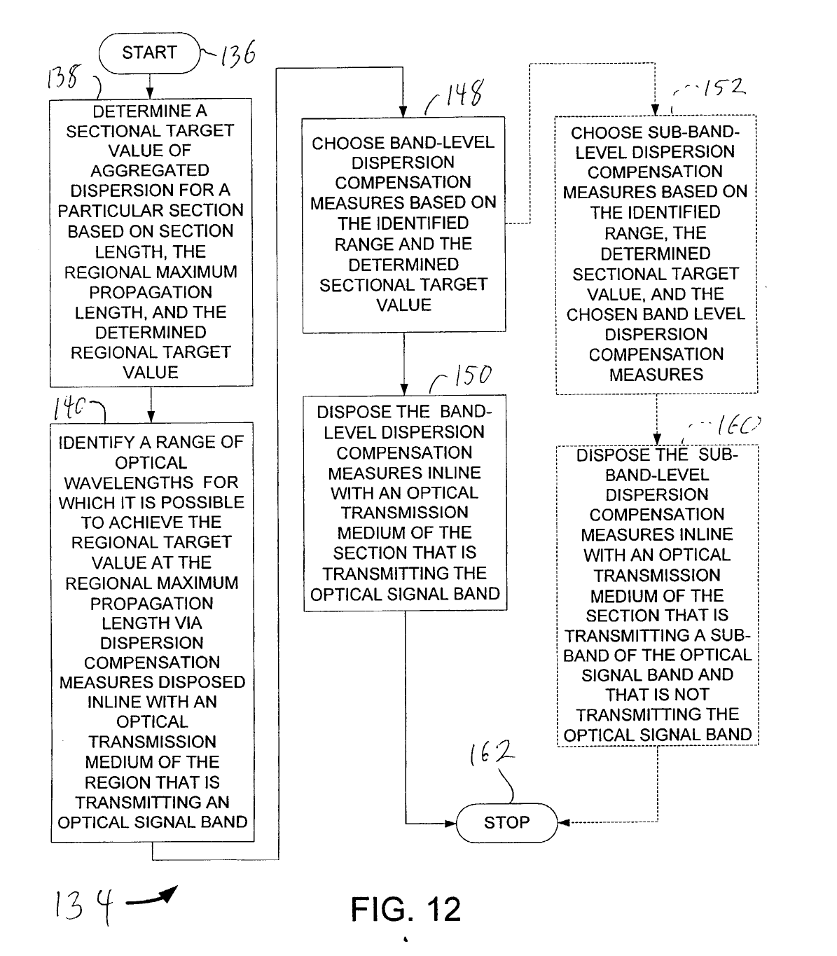

It may be necessary in some cases, however, to supplement with sub-band-level pre- and post-compensators operably disposed inline with the optical transmission medium of various nodes of the region at points of transmission wherein the optical transmission medium is transmitting an optical signal sub-band (group of channels of proximate wavelengths not comprising the entire optical signal band) and not transmitting an optical signal band. This point is more fully discussed below with reference to FIGS. 12-15.

With dispersion compensation measures operably applied at step 130, method 119 ends at 132. Steps 128 and 130, however, are more closely examined below as a method 134 of performing partial dispersion compensation is disclosed for when it is not possible to achieve the regional target value at the maximum propagation length for the entire spectral band with band-level dispersion compensation measures alone. With reference to FIG. 12, method 134 begins at 136 and proceeds to step 138, wherein a sectional target value of aggregated dispersion for a particular section is determined based on section length, the regional maximum propagation length, and the determined regional target value. This step is substantially the same as step 128 (FIG. 7) of method 119.

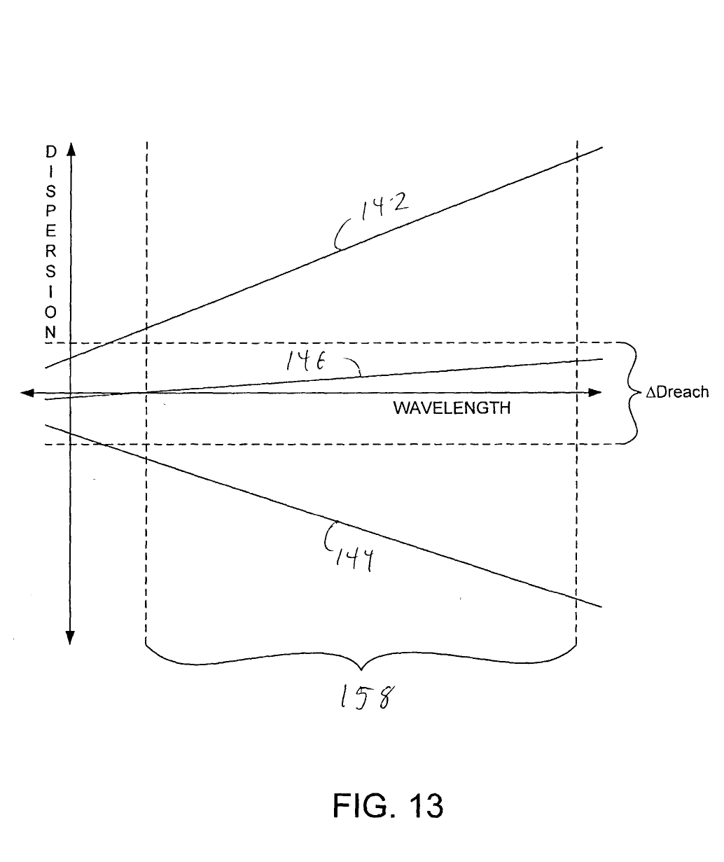

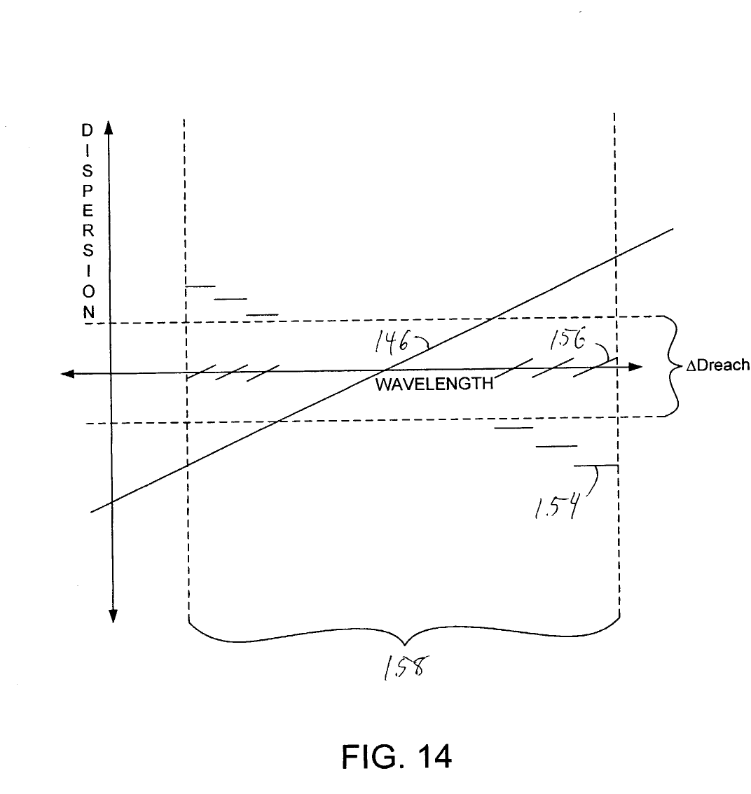

With the prorated values determined in step 138 (FIG. 12), the method 134 proceeds to step 140, wherein a range of optical wavelengths of an optical signal band is identified. This range is identified based on achievability of the regional target value at the maximum propagation length via dispersion compensation measures disposed inline with an optical transmission medium of the identified, switch-ready optical network region that is transmitting the optical signal band. Thus, if one discovers that it is not possible to adequately dispersion compensate a section within the corresponding sectional dispersion tolerance window for all wavelengths of the optical signal band, then one has identified a range of wavelengths for which it is possible to achieve dispersion sectionalization and at least one range for which it is not possible to achieve dispersion sectionalization at the maximum propagation length. The entire optical signal band will generally still be adequately compensated at a shorter reach within the identified, switch-ready optical network region, but additional measures may be optionally applied at more distant nodes. Similarly, if one finds that the entire band can be adequately compensated for the maximum propagation length, then one has also identified a range of wavelengths for which it is possible to achieve dispersion sectionalization at the maximum propagation length. This case is illustrated in FIG. 13, wherein dispersion at the receiver is plotted versus wavelength. Therein, the aggregate link dispersion (total accumulated dispersion for a link including all fiber spans but not band DCM dispersion) as at 142 is adequately compensated by band-level compensators as at 144 to achieve a net link dispersion as at 146 within the dispersion tolerance window ΔD_{reach} of the receiver at the maximum propagation length for any channel within the whole band 158. Similarly, the preceding case is illustrated in FIG. 14, wherein dispersion at the receiver is similarly plotted versus wavelength. Therein, the aggregate link dispersion is inadequately compensated to achieve a net link dispersion as at 146 that is only partially within the dispersion tolerance window ΔD_{reach} of the receiver at the maximum propagation length when the whole band 158 is considered.

In either case, with the sectionalizable range of wavelengths identified in step 140, the method 134 proceeds to step 148, wherein band-level dispersion compensation measures are chosen based on the identified range of wavelengths and the determined sectional target value. This step 148 follows essentially the same methodology as described above with reference to step 130 (FIG. 7). Thus, band-level line compensators and band-level pre-and post-compensators are chosen according to the aforementioned procedure, especially where the identified range of wavelengths comprises the entire optical signal band as in the case of FIG. 13. In the case of FIG. 14, however, an adjustment may optionally be made to adequately compensate one end of the spectral band in favor of another, thereby adjusting the range of wavelengths in one direction or another. In general, however, band-level line compensators and band-level pre- and post-compensators are chosen according to the same aforementioned procedure, as in the case illustrated in FIG. 14, such that wavelengths outside the identified range generally cluster above and below the identified wavelength range.

With band-level dispersion compensation measures chosen in step 148 (FIG. 12), the method 134 proceeds to step 150, wherein the selected band-level dispersion compensation measures are operably disposed inline with an optical transmission medium of the corresponding section that is transmitting the optical signal band. In the case where the identified range of wavelengths does not comprise the entire optical signal band, then wavelengths and/or sub-bands may be left point to point connected and/or switched within a shorter reach, wherein it is possible to adequately compensate to achieve a net link dispersion within the dispersion tolerance window(s) ΔD_{reach} of receivers at the shorter reach. As mentioned previously, however, one of the advantages of the present invention is the ability to add sub-band and/or wavelength level dispersion compensation measures as desired to accommodate increased switchability. Thus, method 134 incorporates an optional, additional path.

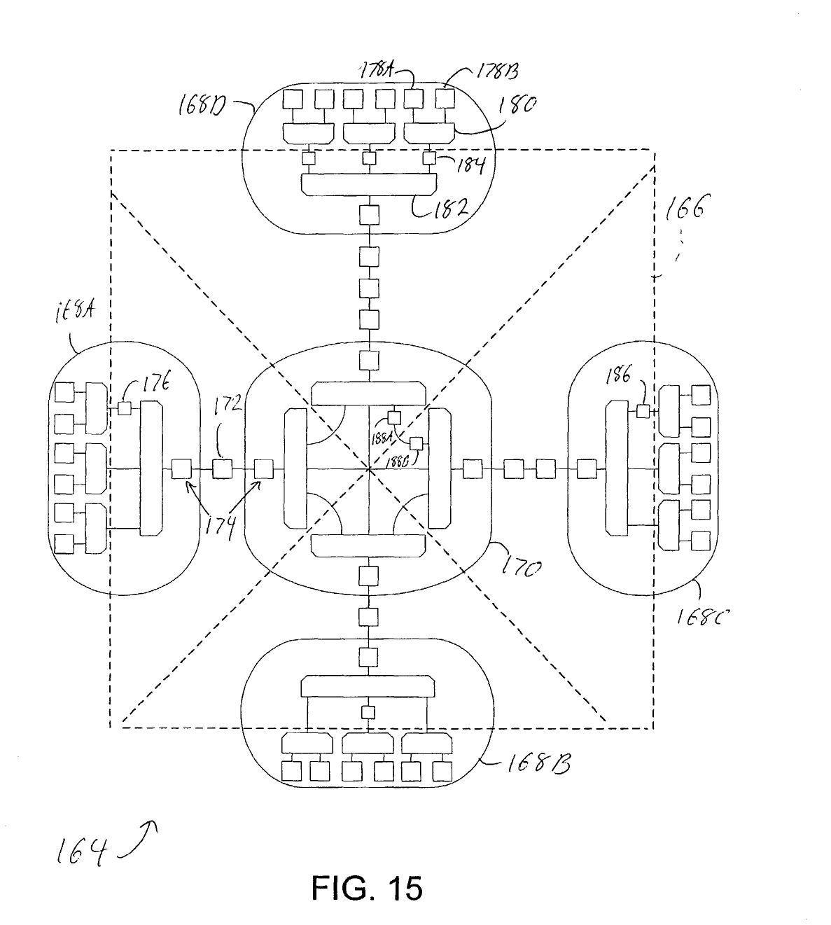

With band-level dispersion compensation measures chosen at 148 (and potentially redefining the range of wavelengths), the method 134 may optionally proceed to step 152, wherein sub-band level (and/or wavelength level) dispersion compensation measures are chosen based on the identified (and perhaps redefined) range of wavelengths, the determined sectional target value, and the chosen band-level dispersion compensation measures. In this case, the sub-band level compensators are chosen to compensate sub-bands of wavelengths lying outside of the range of wavelengths. The sub-band level dispersion compensation measures are chosen to compensate for residual dispersion according to FIG. 14. Therein, sub-band-level compensation as at 154 is applied to achieve a net link dispersion for that sub-band that lies within the dispersion tolerance window of the receiver at the maximum propagation length as at 156. It is possible to use sub-band-level (and/or wavelength level) compensation measures in this manner to adequately compensate the entire optical signal band 158 if desired. Further options may also be exercised, wherein a sub-band-level (and/or wavelength level) dispersion compensation measure can be chosen to be tunable or fixed. This option is more fully discussed below with reference to FIG. 15.

Once sub-band-level (and/or wavelength level) dispersion compensation measures are chosen at step 152, the method 134 proceeds to step 160, wherein the sub-band-level (and/or wavelength level) dispersion compensation measures are operably disposed inline with an optical transmission medium of a corresponding section that is transmitting the appropriate sub-band (or wavelength) of the optical signal band and is not transmitting the optical signal band. Thence, method 134 ends at 162.

Referring to FIG. 15, an exemplary switch-ready optical communications system 164 exhibits dispersion sectionalization 166 according to the present invention. Therein, sub-bands may be routed to and from any transmitting/receiving node 168A-168D via transparent switching node 170 by virtue of band-level line compensators 172 and band-level pre/post compensators 174 chosen to adequately compensate an identified range of wavelengths according to the present invention. This functionality is further made possible by sub-band-level pre/post compensators 176 strategically chosen and operably applied to the system 164. For example, consider two wavelengths generated by transponders 178A and 178B formed into a sub-band by sub-band multiplexer 180, further joined with other sub-bands to form an optical signal band by band multiplexer 182, and routed from node 168D to 168C. Further consider that this route is of too great a length for this sub-band to be adequately dispersion compensated according to the present invention by band-level dispersion compensation measures alone. In this case, an appropriate sub-band-level dispersion compensation measure 184 may be chosen and disposed inline with optical fiber transmitting the sub-band between, for example, sub-band multiplexer 180 and band multiplexer 182. A complimentary measure 186 may further be similarly disposed at the receiver site, and these measures may be fixed, or made tunable as needed. Further, where fixed sub-band-level (and/or wavelength level) dispersion compensation measures will not suffice alone, another option exists, wherein additional fixed sub-band-level dispersion compensation measures are added at one or more switching nodes as at 188A and 188B. Also, instead of using sub-band compensators for the insufficiently sectionalized channels within the switching nodes, one can use channel or subband level tunable compensators at the receiver site. These tunable compensators are tuned to bring total accumulated dispersion of the signal directed to the receiver by the switch fabric of the network within the target dispersion window. Further, the option to leave a sub-band (and/or wavelength) point to point connected or only switchable within a sufficiently short reach still remains. These options may be combined as needed in a cost effective manner to achieve a switch-ready optical communications system with reduced (and perhaps eliminated) need for OEO conversions and/or tunable dispersion compensation measures.

While the invention has been described in its presently preferred form, it will be understood that the invention is capable of modification without departing from the spirit and scope of the invention as set forth in the appended claims.

What is claimed is:

1. A sectionalized dispersion compensation architecture for use with an optical network, comprising:
an identified, switch-ready optical network region having a maximum propagation length;
a dispersion section of said region having a section length; and
dispersion compensation measures operably applied to said dispersion section, wherein said dispersion compensation measures are selected based on the section length, the maximum propagation length, and at least one determined regional target value of regional aggregated dispersion.

2. The architecture of claim 1, wherein said identified, switch-ready optical network region comprises:
a transmitting node operable to generate an optical signal in an optical domain;
a receiving node operable to receive the signal in the optical domain and convert the signal to an electrical domain;
an optical switching nodes operable to route the signal in the optical domain through said region; and
an optical transmission medium operable to transmit the signal in the optical domain between nodes of said identified, switch-ready region,
wherein there exist at least two transparent paths of transmission for the optical signal from the transmitting node to the receiving node.

3. The architecture of claim 2, wherein said dispersion section comprises:
relevant portions of two neighboring nodes of said identified, switch-ready optical network region, wherein at least one of the nodes is an optical switching node; and
a sectional portion of said optical transmission medium, wherein said sectional portion transmits a signal in an optical domain between said two neighboring nodes.

4. The architecture of claim 3, wherein said dispersion compensation measures comprise:
a plurality of band-level line compensators operably disposed inline with said sectional portion of said optical transmission medium at a point of transmission wherein said sectional portion is transmitting an optical signal band; and
band-level pre- and post-compensators operably disposed inline with said sectional portion at a point of transmission wherein said sectional portion is transmitting an optical signal band.

5. The architecture of claim 4, wherein said dispersion compensation measures are selected based on an identified range of wavelengths of the optical signal band for which it is possible to achieve at least one determined regional target value at the determined maximum propagation length via dispersion compensation measures disposed inline with an optical transmission medium of the region that is transmitting the optical signal band.

6. The architecture of claim 5, wherein said dispersion compensation measures comprise sub-band-level dispersion compensation measures operably disposed inline with said sectional portion at a point of transmission wherein said sectional portion is transmitting a sub-band of the optical signal band, and is not transmitting the optical signal band, and
wherein said band-level dispersion compensation measures and said sub-band-level dispersion compensation measures are selected based on the identified range.

7. The architecture of claim 6, wherein said sub-band-level dispersion compensation measures comprise a tunable dispersion compensation measure at a receiving node of said identified, switch-ready region.

8. The architecture of claim 6, wherein said sub-band-level dispersion compensation measures comprise fixed dispersion compensation measures at said neighboring nodes of said dispersion section.

9. The architecture of claim 5, wherein said dispersion compensation measures comprise wavelength-level dispersion compensation measures operably disposed inline with said sectional portion at a point of transmission wherein said sectional portion is transmitting a wavelength of the optical signal band, and is not transmitting the optical signal band, and
wherein said band-level dispersion compensation measures and said wavelength-level dispersion compensation measures are selected based on the identified range.

10. The architecture of claim 9, wherein said wavelength-level dispersion compensation measures comprise a tunable dispersion compensation measure at a receiving node of said identified, switch-ready region.

11. The architecture of claim 1, wherein said determined regional target value of aggregated dispersion is based on the maximum propagation length, a modulation format of the optical signal, an optical power level of the optical signal, and a fiber type of the optical transmission medium.

12. The architecture of claim 1, wherein said determined regional target value of aggregated dispersion is based on dispersion tolerance of at least one receiving node of said identified, switch-ready region.

13. The architecture of claim 1, wherein the determined regional target value is based on uncertainties in performance of at least one optical communications system component under non-ideal operating conditions.

14. The architecture of claim 1, wherein selection of said dispersion compensation measures comprises determination of a sectional target value of aggregated dispersion for said dispersion section based on the determined regional target value, the length of the dispersion section, and the determined maximum propagation length.

15. The architecture of claim 1, wherein determination of the sectional target value D_{sec} of aggregated dispersion for the dispersion section is based on the determined regional target value D_{reach}, the length of the dispersion section L_{sec}, and the determined maximum propagation length L_{reach} according to:
$${D}_{sec} = {D}_{reach} * \frac{{L}_{sec}}{{L}_{reach}} .$$

16. A method of constructing a sectionalized dispersion compensation architecture for use with an optical network, comprising:
determining a maximum propagation length for a switch-ready optical network region, wherein the switch-ready optical network region comprises a plurality of optical network nodes interconnected by an optical transmission medium, wherein at least one node of the region is an optical switching node transparently routing at least one optical signal between two other nodes of the region;
determining at least one regional target value of aggregated dispersion based on the determined maximum propagation length; and
prorating the determined regional target value to a dispersion section of the region, wherein a dispersion section comprises two neighboring nodes of the region and the optical transmission medium connecting the two neighboring nodes.

17. The method of claim 16, comprising selecting dispersion compensation measures for the dispersion section based on said prorating.

18. The method of claim 17, comprising operably applying the selected dispersion compensation measures to the dispersion section.

19. The method of claim 16, wherein said prorating is performed for each dispersion section of the region, the method comprising:
selecting dispersion compensation measures for each dispersion section of the region based on said prorating; and
operably applying the selected dispersion compensation measures to corresponding dispersion sections of the region.

20. The method of claim 16, wherein said determining a regional target value of aggregated dispersion is based on a modulation format of the optical signal, an optical power level of the optical signal, and a fiber type of the optical transmission medium.

21. The method of claim 16, wherein said determining a regional target value is based on a dispersion tolerance of at least one receiver of the switch-ready region.

22. The method of claim 16, wherein said determining a regional target value is based on uncertainties in performance of at least one optical communications system component under non-ideal operating conditions.

23. The method of claim 16, wherein said prorating corresponds to determining a sectional target value of aggregated dispersion for a dispersion section based on the determined regional target value, a length of the dispersion section, and the determined maximum propagation length.

24. The method of claim 16, wherein the sectional target value D_{sec} of aggregated dispersion for the dispersion section is based on the determined regional target value D_{reach}, the length of the dispersion section L_{sec}, and the determined maximum propagation length L_{reach} according to:
$${D}_{sec} = {D}_{reach} * \frac{{L}_{sec}}{{L}_{reach}} .$$

25. The method of claim 16, comprising identifying the switch-ready optical network region.

26. The method of claim 16, comprising identifying a range of optical wavelengths for which it is possible to achieve the regional target value at the determined maximum propagation length via dispersion compensation measures disposed inline with an optical transmission medium of the region that is transmitting an optical signal band.

27. The method of claim 26, comprising choosing band-level dispersion compensation measures based on said prorating and the identified range.

28. The method of claim 27, comprising disposing the band-level dispersion compensation measures inline with an optical transmission medium of the section, wherein the optical transmission medium is transmitting the optical signal band.

29. The method of claim 26, comprising choosing sub-band-level dispersion compensation measures based on said prorating and the identified range.

30. The method of claim 29, comprising disposing the sub-band-level dispersion compensation measures inline with an optical transmission medium of the section, wherein the optical transmission medium is transmitting a sub-band of the optical signal band, and is not transmitting the optical signal band.

31. The method of claim 26, comprising choosing wavelength-level dispersion compensation measures based on said prorating and the identified range.

32. The method of claim 31, comprising disposing the wavelength-level dispersion compensation measures inline with an optical transmission medium of the section, wherein the optical transmission medium is transmitting a wavelength of the optical signal band, and is not transmitting the optical signal band.

33. An optical communications system, comprising:
a plurality of edge nodes operable to generate and receive optical signals in an optical domain;
a plurality of optical switching nodes operable to route the optical signals without causing the optical signals to exit the optical domain;
an optical transmission medium operably communicating optical signals between neighboring nodes of the system, wherein a maximum propagation length L_{reach} is defined according to a maximum length of optical signal propagation through said optical transmission medium according to predefined system routing methodology, and wherein a system target value D_{reach} of aggregated dispersion is defined according to a substantially worst case scenario of the maximum propagation length L_{reach} dispersion tolerance of system receiving nodes, a modulation format of the optical signal, an optical power level of the optical signal, and a fiber type of the optical transmission medium; and
dispersion compensation measures operably applied to neighboring nodes and said optical transmission medium therebetween, wherein a dispersion section length L_{sec} is defined according to a length of said optical transmission medium therebetween, and wherein said measures are selected to compensate for a sectional target value D_{sec} of aggregated dispersion according to:
$${D}_{sec} = {D}_{reach} * \frac{{L}_{sec}}{{L}_{reach}} .$$

34. The system of claim 33, wherein said dispersion compensation measures are selected based on an identified range of wavelengths of an optical signal band for which it is possible to achieve the system target value at the maximum propagation length via dispersion compensation measures disposed inline with an optical transmission medium of the system that is transmitting the optical signal band, and wherein said dispersion compensation measures comprise:
a plurality of band-level line compensators operably disposed inline with said optical transmission medium at a point of transmission wherein said optical transmission medium is transmitting the optical signal band;
band-level pre- and post-compensators operably disposed inline with said optical transmission medium at a point of transmission wherein said optical transmission medium is transmitting an optical signal band; and
sub-band-level dispersion compensation measures operably disposed inline with said optical transmission medium at a point of transmission wherein said optical transmission medium is transmitting a sub-band of the optical signal band, and is not transmitting the optical signal band.

35. The system of claim 34, further comprising wavelength-level dispersion compensation measures operably disposed inline with said optical transmission medium at a point of transmission wherein said optical transmission medium is transmitting a wavelength of the optical signal band, and is not transmitting the optical signal band.
